(19) United States
(12) Patent Application Publication
(10) Pub. No.: US 2007/0054540 A1
(43) Pub. Date: Mar. 8, 2007

(54) Method of connecting a cable with an electrical connector

(75) Inventor: Hiroshi Takeda, Tokyo (JP)

Correspondence Address: NIXON PEABODY, LLP, 401 9TH STREET, NW, SUITE 900, WASHINGTON, DC, 20004-2128, US

(73) Assignee: I-PEX CO., LTD., Tokyo (JP)

(21) Appl. No.: 11/484,688

(22) Filed: Jul. 12, 2006

(30) Foreign Application Priority Data
Aug. 9, 2005 (JP) 2005-230360

(51) Int. Cl. H01R 4/24

(52) U.S. Cl. 439/404

(57) ABSTRACT

A method of connecting a cable with an electrical connector comprises the steps of stripping partially insulating material from a lead constituting a cable to bare partially a core wire covered with the insulating material, disposing the bared core wire between first and second protruding members of a conductive contact provided on an electrical connector and having respectively first and second outside end portions each slanting in regard to a predetermined direction, and exerting force in the predetermined direction on the first and second outside end portions for transforming each of the first and second protruding members to shift from the outside to the inside so as to come in press-contact with the bared core wire, so that the bared core wire put between the first and second protruding members is electrically connected with the conductive contact.

### BACKGROUND OF THE INVENTION

1. Field of the Invention

The present invention relates generally to a method of connecting a cable with an electrical connector, and more particularly to an improvement in a method of connecting a cable which is constituted with one or more leads each having a core wire covered with insulating material with an electrical connector which has one or more conductive contacts with each of which the core wire is connected electrically.

2. Description of the Prior Art

There has been proposed to use often a pair of electrical connectors which are coupled with each other for connecting electrically at least a couple of electrical parts, electrical devices or electrical apparatus with each other through a cable which is provided with one or more core wires each covered with insulating material. One of the electrical connectors is formed into a plug type and the other of the electrical connectors is formed into a receptacle type. The electrical connector of the plug type is partially inserted into the electrical connector of the receptacle type in such a manner that one or more conductive contacts provided in the electrical connector of the plug type come into contact with one or more conductive contacts provided in the electrical connector of the receptacle plug type so that the electrical connector of the plug type is electrically connected with the electrical connector of the receptacle type.

When such a pair of electrical connectors as mentioned above are put to practical use, the electrical connectors are in a condition in which one of them is provided on electrical parts, an electrical device or an electrical apparatus and the other of them is connected with a cable extending from another electrical parts, electrical device or electrical apparatus, or each of them is connected with a cable extending from a corresponding electrical parts, electrical device or electrical apparatus. The cable is constituted with a lead having a core covered with insulating material or a plurality of leads each having a core wire covered with insulating material. The core wire is constituted with a single wire or a stranded wire. For connecting the cable with the electrical connector, it is necessary to connect electrically the core wire of the lead with the conductive contact provided in the electrical connector or to connect electrically the core wires of the leads with the conductive contacts provided in the electrical connector, respectively.

A previously provided method of connecting the cable constituted with the plural leads each having the core wire covered with insulating material with the electrical connector having the plural conductive contacts, by which the core wires of the leads are electrically connected with the conductive contacts provided in the electrical connector, respectively, is put into practice as explained with reference to FIGS. 1 and 2.

In the method explained with reference to FIGS. 1 and 2, an electrical connector 11, a cable 12 and a pressing piece 13 are put to use. The electrical connector 11 has a housing 14 made of insulator on which a plurality of conductive contacts 15 are provided to project outward. Each of the conductive contact 15 is formed into a pair of parallel protruding members each having a pointed end. In the housing 14, a connecting portion is provided for engaging with another electrical connector and the conductive contacts 15 extend from the connecting portion.

The cable 12 is constituted with a plurality of leads 16 each having a core wire 17 covered with insulator material. The leads 16 are arranged to be shaped into a thin board. The core wires 17 of the leads 16 are arranged at equal intervals corresponding to intervals at which the conductive contacts 15 are provided on the housing 14.

The pressing piece 13 is made of insulating material to have catching portions 18 for engaging with the housing 14 of the electrical connector 11. On the pressing piece 13, a plurality of grooves 19 are provided at equal intervals corresponding to the intervals at which the leads 16 of the cable 12 is arranged.

When the core wires 17 of the leads 16 constituting the cable 12 are electrically connected with the conductive contacts 15 provided on the housing 14 of the electrical connector 11, the cable is disposed above the electrical connector 11 as shown in FIG. 1 and the leads 16 are positioned to correspond to the conductive contacts 15, respectively. Then, the leads 16 are pressed down to the conductive contacts 15 by the pressing piece 13. The pressing piece 13 is so disposed that the grooves 19 provided thereon are positioned to correspond to the leads 16, respectively, and the catching portions 18 engage with the housing 14 of the electrical connector 11 for keeping the pressing piece 13 at the position for pressing the leads 16 down to the conductive contacts 15 and constituting an assembly shown in FIG. 2.

With the operation for pressing the leads 16 put on the conductive contacts 15 down to the conductive contacts 15 by the pressing piece 13 so that the pressing piece 13 engages with the housing 14 of the electrical connector 11, as shown in FIG. 2, it is expected that the core wire 17 of each of the leads 16 is electrically connected to the corresponding conductive contact 15. That is, when the leads 16 are pressed down to the conductive contacts 15 by the pressing piece 13, it can be expected that the point ends of the parallel protruding members of each of the conductive contacts 15 are in operation to pierce the insulating material covering the core wire 17 of the corresponding lead 16 and come into contact with the core wire 17.

Accordingly, if the point ends of the parallel protruding members of each of the conductive contacts 15 operate to meet expectations in the assembly shown in FIG. 2, the core wires 17 of the leads 16 constituting the cable 12 are electrically connected appropriately with the conductive contacts 15, respectively.

It has been also proposed previously another method of connecting the cable constituted with the lead having the core wire covered with insulating material with the electrical connector having the conductive contact, by which the core wire of the lead is electrically connected with the conductive contact provided in the electrical connector. In the electrical connector used for this method, the conductive contact has a pair of divided portions forming a slit between their inside parts opposite to each other and the lead is pushed in the slit in such a manner as to be prevented from going out of the slit, as disclosed in, for example, the Japanese utility model application published before examination under publication number Showa 58-5282.

In the previous proposal disclosed in the publication mentioned above, in the electrical connector, each of the divided portions of the conductive contact is provided with a bump projecting into the slit at the inside part thereof so that the thorn-shaped prominences provided on the divided portions of the conductive contact are opposite to each other in the slit. When the lead constituting the cable is pushed in the slit, the inside part of each of the divided portions of the conductive contact cuts into the insulator covering the core wire of the lead and comes into contact with the core wire. Then, the lead is checked by the bump provided at the inside part of each of the divided portions so as to be prevented from going out of the slit.

Accordingly, if the conductive contact having the divided portions each provided with the bump at its inside part acts on the lead to meet expectations, the core wire of the lead constituting the cable is stably maintained to be electrically connected appropriately with the conductive contact provided in the electrical connector.

In the above-mentioned previously proposed method of connecting the cable with the electrical connector, in which the leads constituting the cable put on the conductive contacts provided in the electrical connector are pressed down to the conductive contacts by the pressing piece and thereby it is expected that the core wire of each of the lead is electrically connected appropriately with the corresponding conductive contact, there is a problem that the connection of the core wire of each of the leads with the corresponding conductive contact is lacking in certainty.

For example, in the case of the method explained with reference to FIGS. 1 and 2 or the like, when the leads constituting the cable are pressed down to the conductive contacts by the pressing piece, it may be brought about that the point ends of the parallel protruding members of each of the conductive contacts cannot pierce appropriately the insulating material covering the core wire of the corresponding lead and thereby do not come into contact with the core wire, or, that the point ends of the parallel protruding members of each of the conductive contacts operate not only to pierce the insulating material covering the core wire of the corresponding lead but also to cut the core wire off. A desirable state in which the core wire of each of the lead is electrically connected appropriately with the corresponding conductive contact cannot be obtained in either case. Therefore, the connection of the core wire of each of the leads with the corresponding conductive contact comes to lack in certainty.

Further, in the case of the method disclosed in the publication mentioned above or the like, in which the cable constituted with the lead having the core wire covered with insulating material is connected to the electrical connector provided with the conductive contact having the divided portions which forms the slit between their inside parts opposite to each other and each of which is provided with the bump projecting into the slit at the inside part thereof, in such a manner that the lead constituting the cable is pushed in the slit and thereby it is expected that the inside part of each of the divided portions of the conductive contact cuts into the insulator covering the core wire of the lead so as to come into contact with the core wire and the lead is checked by the bump provided at the inside part of each of the divided portions so as to be prevented from going out of the slit, there is also a problem that the connection of the core wire of the lead with the conductive contact is lacking in certainty.

That is, when the lead constituting the cable is pushed in the slit formed between the inside parts of the divided portions provided on the conductive contact, it may be brought about that the inside parts of the divided portions cannot cut adequately into the insulating material covering the core wire of the lead and thereby do not come into contact with the core wire, or, that the inside parts of the divided portions operate to cut excessively into the insulating material covering the core wire of the lead so as to cut the core wire off. Therefore, the connection of the core wire of the lead with the conductive contact comes to lack in certainty. For example, when the core wire is a fine seven-stranded wire produced by twisting seven threads each having a diameter of 0.127 mm to have a diameter of 0.38 mm and covered with insulating material having a thick of 0.41 mm to form the lead having a diameter of 1.2 mm is used, it is likely that the core wire which is the fine seven-stranded wire is cut off when the lead constituting the cable is pushed in the slit formed between the inside parts of the divided portions provided on the conductive contact.

It can be considered to fractionate operations for connecting the cable with the electrical connector so as to increase the amount of work as much as practicable for the purpose of avoiding the above-mentioned problems. However, to increase the amount of work itself brings about another severe problem and therefore it is generally desired to carry out the connection of the cable with the electrical connector with a relatively small amount of work.

### OBJECTS AND SUMMARY OF THE INVENTION

Accordingly, it is an object of the present invention to provide a method of connecting a cable constituted with one or more leads each having a core wire covered with insulating material with an electrical contact having one or more conductive contacts with each of which the core wire is electrically connected, which avoids the aforementioned disadvantages encountered with the prior art.

Another object of the present invention is to provide a method of connecting a cable constituted with one or more leads each having a core wire covered with insulating material with an electrical contact having one or more conductive contacts with each of which the core wire is electrically connected, with which the core wire of the lead can be electrically connected with the conductive contact corresponding to the core wire to be superior in certainty with a relatively small amount of work.

A further object of the present invention is to provide a method of connecting a cable constituted with one or more leads each having a core wire covered with insulating material with an electrical contact having one or more conductive contacts with each of which the core wire is electrically connected, with which each of the core wires of the leads is caused surely to come into contact with a corresponding one of the conductive contacts with a relatively small amount of work, so that the core wires are electrically connected appropriately with the conductive contacts, respectively.

According to the present invention, as claimed in any one of claims, there is provided a method of connecting a cable with an electrical connector, which comprises the steps of stripping partially insulating material from a lead constituting a cable and having a core wire covered with the insulating material to bare the core wire, putting the core wire of the lead bared partially on a conductive contact provided on an electrical connector and having a forked portion formed into first and second protruding members opposite to each other, said first and second protruding members having respectively first and second outside end portions each slanting in regard to a predetermined direction, disposing the bared core wire of the lead to be positioned between the first and second protruding members of the conductive contact, and exerting force in the predetermined direction on the first and second outside end portions for transforming each of the first and second protruding members to shift from the outside to the inside so as to come in press-contact with the core wire of the lead, so that the core wire put between the first and second protruding members is electrically connected with the conductive contact and thereby the cable is connected with the electrical connector.

Especially, in one embodiment of method according to the present invention, a pressing means operative to engage with the first and second outside end portions of the first and second protruding members and move in the predetermined direction to press the first and second outside end portions is used for exerting the force in the predetermined direction on the first and second outside end portions.

With the method thus carried out in accordance with the present invention, under a condition in which the core wire of the lead bared partially is put on the conductive contact provided on the electrical connector and having the first and second protruding members opposite to each other, which have respectively the first and second outside end portions each slanting in regard to the predetermined direction, and disposed to be positioned between the first and second protruding members of the conductive contact, the force in the predetermined direction is exerted on the first and second outside end portions, for example, with the aid of the pressing means. With such force in the predetermined direction exerted on the first and second outside end portions of the first and second protruding members, each of the first and second protruding members is transformed to shift from the outside to the inside so as to come in press-contact with the core wire of the lead. As a result, the core wire put between the first and second protruding members is electrically connected with the conductive contact and thereby the cable is connected with the electrical connector.

In the method according to the present invention, each of the steps of stripping partially the insulating material from the lead, putting the core wire of the lead bared partially on the conductive contact, disposing the bared core wire to be positioned between the first and second protruding members and exerting the force in the predetermined direction on the first and second outside end portions is able to be carried out with simple and a relatively small amount of work. Further, since the core wire of the lead bared partially is surely put between the first and second protruding members of the conductive contact to be electrically connected appropriately with the conductive contact, the connection of the core wire with the conductive contact can be carried out without hindrance by the insulating material covering the core wire and a fear of cutting off of the core wire.

Accordingly, with the method according to the present invention, when the cable is connected with the electrical connector, the core wire of the lead constituting the cable is caused surely to come into contact with the conductive contact of the electrical connector with the relatively small amount of work, so that the core wire can be electrically connected appropriately with the conductive contact to be superior in certainty.

The above, and other objects, features and advantages of the present invention will become apparent from the following detailed description taken in conjunction with the accompanying drawings.

### BRIEF DESCRIPTION OF THE DRAWINGS

FIGS. 1 and 2 are schematic perspective views used for explaining a previously proposed method of connecting a cable with an electrical connector;

FIGS. 3 to 5 are schematic side views used for explaining the steps of an embodiment of method according to the present invention;

FIG. 6 is a schematic perspective view showing a pressing means used in the embodiment of method according to the present invention;

FIGS. 7 to 9 are schematic side views used for explaining the steps of the embodiment of method according to the present invention; and

FIG. 10 is a schematic side view showing conductive contacts provided on an electrical connector used in another embodiment of method according to the present invention.

### DESCRIPTION OF THE PREFERRED EMBODIMENTS

Referring to FIGS. 3 to 9, a first embodiment of method of connecting a cable with an electrical connector according to the present invention is explained as follows.

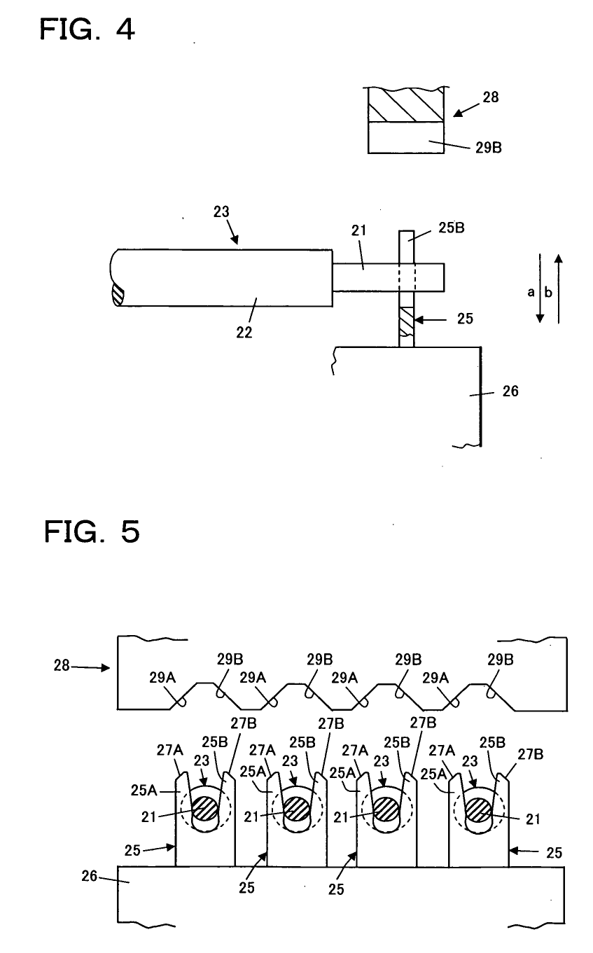

When the first embodiment is carried out, first, a cable which is constituted with a lead 23 having a core wire 21 covered with insulating material 22 such as soft plastics is subjected to the step of stripping partially the insulating material 22 from the lead 23 to bare the core wire 21, as shown in FIG. 3. Then, the cable is subjected to the step of putting the core wire 21 of the lead 23 bared partially on a conductive contact 25 provided on a housing 26 of an electrical connector, a part of which is shown in FIGS. 4 and 5. The conductive contact 25 has a forked portion formed into a pair of protruding members 25A and 25B, respective inside portions of which are opposite to each other. The protruding member 25A has an outside end portion 27A and the protruding member 25B has an outside end portion 27B. Each of the outside end portions 27A and 27B slants in regard to each of a direction indicated with an arrow a (hereinafter, referred to as an a direction) and a direction indicated with an arrow b (hereinafter, referred to as an b direction). The cable is further subjected to the step of disposing the core wire 21 of the lead 23 bared partially to be positioned between the protruding members 25A and 25B of the conductive contact 25.

In the case of the electrical connector having the housing 26 partially shown in FIGS. 4 and 5, the housing 26 is made of insulating material such as solid plastics and four conductive contacts 25 are provided on the housing 26. As shown in FIG. 5, each of four core wires 21 of the leads 23 each bared partially is positioned between the protruding members 25A and 25B of a corresponding one of four conductive contacts 25.

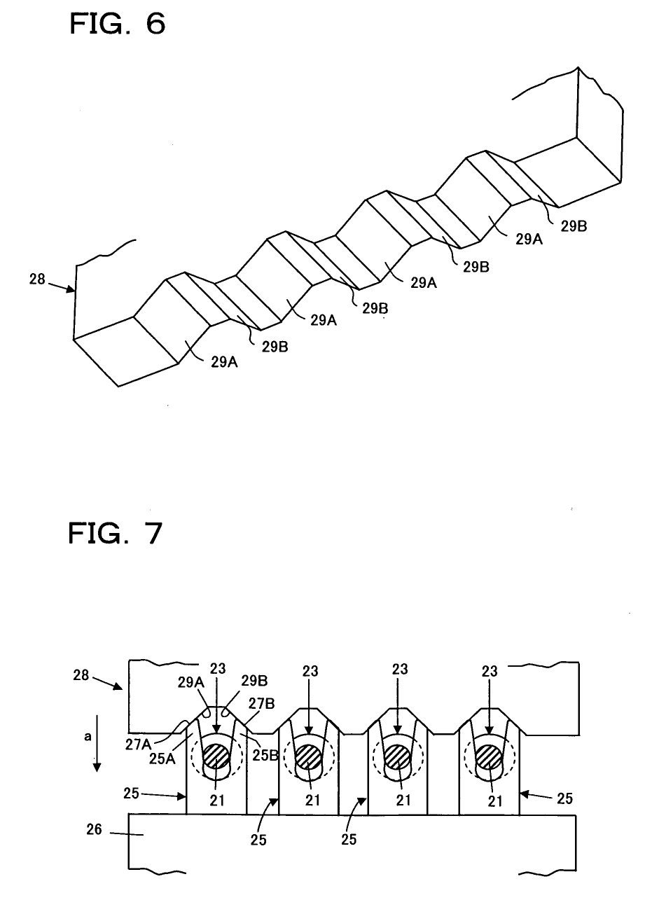

As shown also in FIG. 5, a pressing device 28 which is movable in both of the a and b directions (coming down and coming up) is provided above four conductive contacts 25 each having the protruding members 25A and 25B, between which the core wire 21 of the lead 23 bared partially is positioned. The pressing device 28 is provided with four pairs of sloping surfaces 29A and 29B corresponding to four conductive contacts 25, respectively, as shown in FIGS. 5 and 6. Each of the sloping surfaces 29A and 29B slants in respect to each of the directions a and b and the sloping surfaces 29A and 29B are operative to come into contact with the outside end portion 27A of the protruding member 25A and the outside end portion 27B of the protruding member 25B, respectively, when the pressing device 28 moves in the a direction to be adjacent to the four conductive contacts 25.

Further, the cable is subjected to the step of exerting force in the a direction on the outside end portions 27A and 27B for transforming each of the protruding members 25A and 25B to shift from the outside to the inside so as to come in press-contact with the core wire 21 of the lead 23. In this step, after the housing 26 of the electrical connector is fixed at a predetermined position, the pressing device 28 provided above four conductive contacts 25 each having the protruding members 25A and 25B, between which the core wire 21 of the lead 23 bared partially is positioned, comes down in the a direction to the conductive contacts 25 so as to cause each pair of sloping surfaces 29A and 29B to come into contact with the outside end portion 27A of the protruding member 25A and the outside end portion 27B of the protruding member 25B, respectively, as shown in FIG. 7. Then, the pressing device 28 further comes down continuously in the a direction to press the outside end portions 27A and 27B by the sloping surfaces 29A and 29B for exerting force in the a direction on the outside end portions 27A and 27B.

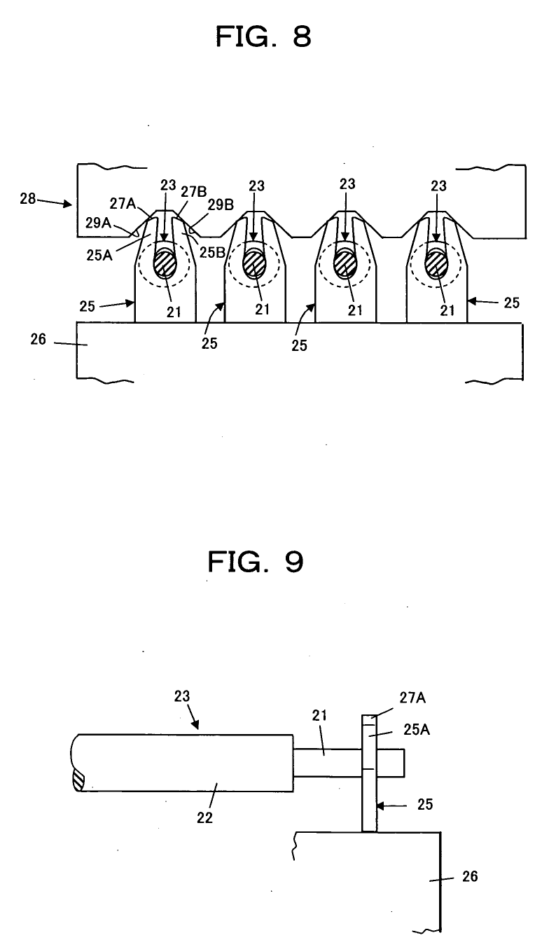

With the force thus exerted on the outside end portions 27A and 27B, each of the protruding members 25A and 25B having the outside end portions 27A and 27B, respectively, is transformed to shift from the outside to the inside so as to come in press-contact with the core wire 21 of the lead 23, as shown in FIG. 8, so that the protruding members 25A and 25B of each of four conductive contacts 25 hold tightly the core wire 21 of the lead 23 which is put between the protruding members 25A and 25B. Thereby, each of four core wires 21 of the leads 23 constituting the cable is electrically connected with the corresponding one of four conductive contacts 25 provided on the housing 26 of the electrical connector.

The above described state in which the protruding members 25A and 25B of each of four conductive contacts 25 hold tightly the core wire 21 of the lead 23 which is put between the protruding members 25A and 25B is made without any hindrance by the insulating material 22 covering the core wire 21 of the lead 23 and a fear of cutting off of the core wire 21. That is, each of four conductive contacts 25 comes into press-contact with the core wire 21 of the lead 23 surely and appropriately with the protruding members 25A and 25B thereof holding tightly the core wire 21 which is put between the protruding members 25A and 25B without any hindrance by the insulating material 22 covering the core wire 21 and the fear of cutting off of the core wire 21, and thereby each of four core wires 21 of the leads 23 is electrically connected appropriately with the corresponding one of four conductive contacts 25.

Accordingly, when the pressing device 28 provided above four conductive contacts 25 comes down in the a direction to the conductive contacts 25 so as to cause each pair of sloping surfaces 29A and 29B to come into contact with the outside end portion 27A of the protruding member 25A and the outside end portion 27B of the protruding member 25B, respectively, and then to press the outside end portions 27A and 27B for exerting force in the a direction on the same and thereby each of the protruding members 25A and 25B having the outside end portions 27A and 27B, respectively, is transformed to shift from the outside to the inside so as to come in press-contact with the core wire 21 of the lead 23 and hold tightly the core wire 21 between the protruding members 25A and 25B, each of four core wires 21 of the leads 23 is electrically connected surely and appropriately with the corresponding one of four conductive contacts 25.

After that, the pressing device 28 is caused to come up in the b direction to return to the original position above four conductive contacts 25 shown in FIGS. 4 and 5 and the first embodiment is finished. As a result, each of four core wires 21 of the leads 23 constituting the cable is electrically connected with the corresponding one of four conductive contacts 25 provided on the housing 26 of the electrical connector, as shown in FIG. 9.

The pressing device 28 may be provided with stoppers at both end portions of its lower surface outside four pairs of sloping surfaces 29A and 29B. These stoppers are operative to avoid certainly an undesirable state in which the pressing device 28 comes down excessively to cause the protruding members 25A and 25B of at least one of four conductive contacts 25 to cut off the core wire 21 of the lead 23.

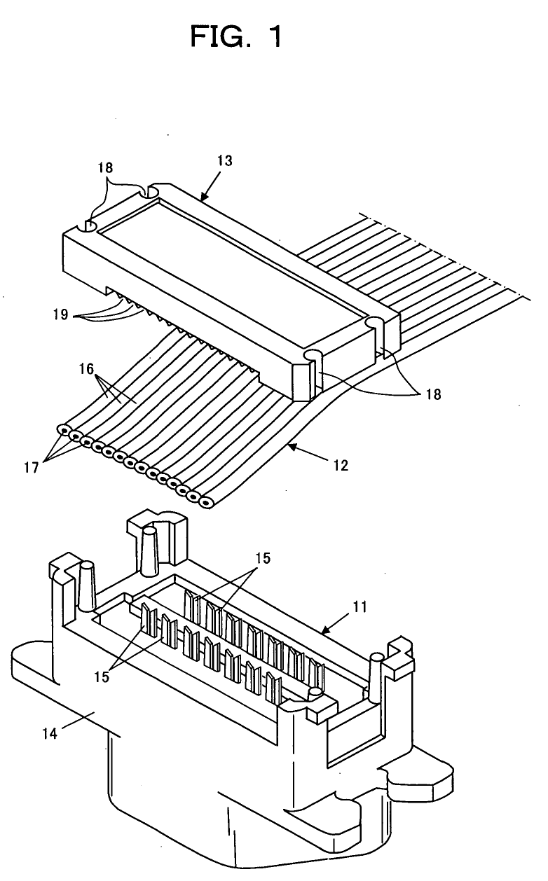

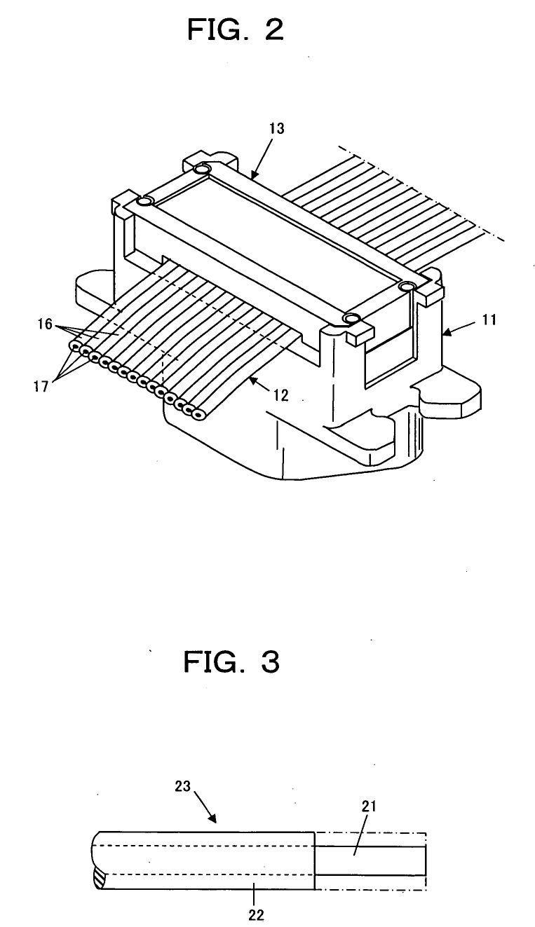

Although the pressing device 28 provided with four pairs of sloping surfaces 29A and 29B is used for exerting the force in the a direction on the outside end portion 27A of the protruding member 25A and the outside end portion 27B of the protruding member 25B of each of four conductive contacts 25 in the first embodiment mentioned above, it is also possible for exerting the force in the a direction on the outside end portion 27A of the protruding member 25A and the outside end portion 27B of the protruding member 25B of each of four conductive contacts 25 to use a pressing device other than the pressing device 28, for example, a pressing piece similar to the pressing piece 13 shown in FIGS. 1 and 2, which is provided with sloping surfaces like four pairs of sloping surfaces 29A and 29B shown in FIG. 6 or a pressing device provided on another electrical contact opposite to the housing 26 on which four conductive contacts 25 are provided, which is provided with sloping surfaces like four pairs of sloping surfaces 29A and 29B shown in FIG. 6.

Further, although each of four core wires 21 of the leads 23 constituting the cable is electrically connected with the corresponding one of four conductive contacts 25 provided on the housing 26 of the electrical connector in the above first embodiment, the number of leads or the number of conductive contacts should not be limited to four and it is possible to set a desirable number of leads or conductive contacts in the method according to the present invention.

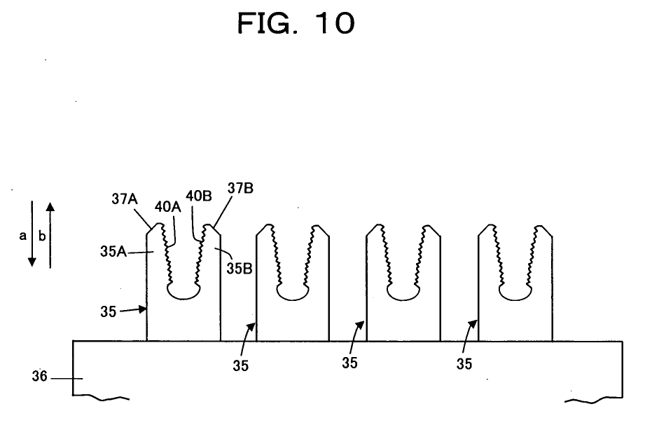

FIG. 10 shows four conductive contacts 35 which are used for carrying out a second embodiment of method of connecting a cable with an electrical connector according to the present invention. These conductive contacts 35 are provided on a housing 36 of an electrical connector, a part of which is shown in FIG. 10.

Each of four conductive contacts 35 has also a forked portion formed into a pair of protruding members 35A and 35B, respective inside portions of which are opposite to each other. The protruding member 35A has an outside end portion 37A and the protruding member 35B has an outside end portion 37B. Each of the outside end portions 37A and 37B slants in regard to each of an a direction indicated with an arrow a and a b direction indicated with an arrow b. In each of four conductive contacts 35, saw-teeth 40A are formed on an inside portion of the protruding members 35A and saw-teeth 40B are formed on an inside portion of the protruding members 35B.

The second embodiment of the method according to the present invention is carried out with four conductive contacts 35 provided on the housing 36 of the electrical connector, instead of four conductive contacts 35 used for carrying out the first embodiment, in a similar manner as the first embodiment, in which each of the protruding members 35A and 35B of each of four conductive contacts 35 is transformed in the same manner as each of the protruding members 25A and 25B of each of four conductive contacts 25 transformed in the first embodiment.

Accordingly, when the second embodiment mentioned above is carried out, each of four core wires of leads constituting a cable and bared partially is put between the inside portions of the protruding members 35A and 35B of one of four conductive contacts 35 to be electrically connected with the conductive contacts 35 provided on the housing 36 of the electrical connector. On that occasion, since the saw-teeth 40A are formed on the inside portion of the protruding members 35A and the saw-teeth 40B are also formed on the inside portion of the protruding members 35B, each of four core wires of the leads constituting the cable and bared partially is held more surely and more firmly between the protruding members 35A and 35B of one of four conductive contacts 35.

What is claimed is:

1. A method of connecting a cable with an electrical connector, which comprises the steps of:
stripping partially insulating material from a lead constituting a cable and having a core wire covered with the insulating material to bare partially the core wire,
putting the core wire of the lead bared partially on a conductive contact provided on an electrical connector and having a forked portion formed into first and second protruding members opposite to each other, said first and second protruding members having respectively first and second outside end portions each slanting in regard to a predetermined direction,
disposing the core wire of the lead bared partially to be positioned between the first and second protruding members of the conductive contact, and
exerting force in the predetermined direction on the first and second outside end portions for transforming each of the first and second protruding members to shift from the outside to the inside so as to come in press-contact with the core wire of the lead, so that the core wire put between the first and second protruding members is electrically connected with the conductive contact and thereby the cable is connected with the electrical connector.

2. A method according to claim 1, wherein pressing means operative to engage with the first outside end portion of the first protruding member and the second outside end portion of the second protruding member and move in the predetermined direction to press the first and second outside end portions is used for exerting the force in the predetermined direction on the first and second outside end portions.

3. A method according to claim 2, wherein said pressing means is provided with first and second sloping surfaces each slanting in respect to the predetermined direction, said first and second sloping surfaces being operative to come into contact with the first outside end portion of the first protruding member and the second outside end portion of the second protruding member, respectively.

4. A method according to claim 1, wherein said conductive contact has saw-teeth formed on an inside portion of each of the first and second protruding members opposite to each other.

5. A method of connecting a cable with an electrical connector, which comprises the steps of:
stripping partially insulating material from each of a plurality of leads constituting a cable and having respective core wires each covered with the insulating material to bare partially the core wires,
putting each of the core wires of the leads bared partially on one of a plurality of conductive contacts provided on an electrical connector and each having a forked portion formed into first and second protruding members opposite to each other, said first and second protruding members having respectively first and second outside end portions each slanting in regard to a predetermined direction,
disposing each of the core wires of the leads bared partially to be positioned between the first and second protruding members of one of the conductive contacts, and
exerting force in the predetermined direction on the first and second outside end portions of each of the conductive contacts for transforming each of the first and second protruding members of each of the conductive contacts to shift from the outside to the inside so as to come in press-contact with one of the core wires of the leads, so that each of the core wires put between the first and second protruding members is electrically connected with said one of the conductive contacts and thereby the cable is connected with the electrical connector.

6. A method according to claim 5, wherein pressing means operative to engage with the first and second outside end portions of each of the conductive contacts and move in the predetermined direction to press the first and second outside end portions is used for exerting the force in the predetermined direction on the first and second outside end portions of each of the conductive contacts.

7. A method according to claim 6, wherein said pressing means is provided with a plurality pairs of first and second sloping surfaces each slanting in respect to the predetermined direction, said first and second sloping surfaces being operative to come into contact with the first and second outside end portions of each of the conductive contacts, respectively.

8. A method according to claim 5, wherein each of said conductive contacts has saw-teeth formed on an inside portion of each of the first and second protruding members opposite to each other.
